(19) United States
(12) Patent Application Publication
(10) Pub. No.: US 2003/0214464 A1
(43) Pub. Date: Nov. 20, 2003

(54) Method for driving plasma display panel

(76) Inventors: Geun Soo Lim, Sungnam-shi (KR); Dai Hyun Kim, Kunpo-shi (KR)

Correspondence Address: FLESHNER & KIM, LLP, P.O. Box 221200, Chantilly, VA, 20153-1200, US

(21) Appl. No.: 10/438,852

(22) Filed: May 16, 2003

(30) Foreign Application Priority Data
May 17, 2002 (KR) P2002-27308

(51) Int. Cl. G09G 3/28

(52) U.S. Cl. 345/60

(57) ABSTRACT

A method of driving a plasma display panel wherein a wide-band flicker can be minimized in a driving method of carrying out a selective writing and a selective erasing at the same time. In the method, the plasma display panel has first and second sustain electrodes and an address electrode and including at least one selective writing sub-fields for expressing a low gray level by turning on selected discharge cells and sustaining a discharge of the turned-on cells, and at least one selective erasing sub-fields for expressing a high gray level by sequentially turning off the cells turned on at the last selective writing sub-field of said selective writing sub-fields. Any one of said selective erasing sub-fields is divided into at least two sub-fields in such a manner to be arranged into low gray level sub-fields. Accordingly, the number of sub-fields in one frame is increased to reduce the vertical frame blank VFB and to enlarge a duty circle of light emission for the middle gray level expression, thereby eliminating a 50 Hz wide-band flicker.

### BACKGROUND OF THE INVENTION

1. Field of the Invention

This invention relates to a method of driving a plasma display panel, and more particularly to a method of driving a plasma display panel wherein a wide-band flicker can be minimized in a driving method of carrying out a selective writing and a selective erasing at the same time.

2. Description of the Related Art

Generally, a plasma display panel (PDP) excites and radiates a phosphorus material using an ultraviolet ray generated upon discharge of an inactive mixture gas such as He+Xe, Ne+Xe or He+Ne+Xe, to thereby display a picture. Such a PDP is easy to be made into a thin-film and large-dimension type. Moreover, the PDP provides a very improved picture quality owing to a recent technical development.

Referring to FIG. 1, a discharge cell of a conventional three-electrode, AC surface-discharge PDP includes a scan electrode Y, a sustain electrode Z, and an address electrode X intersecting the scan electrode Y and the sustain electrode Z.

Each intersection among the scan electrode Y, the sustain electrode Z and the address electrode X is provided with a cell 1 for displaying any one of red, green and blue colors. The scan electrode Y and the sustain electrode Z is provided on an upper substrate (not shown). A dielectric layer and an MgO protective layer (not shown) are disposed on the upper substrate. The address electrode X is provided on a lower substrate (not shown). On the upper substrate is provided a barrier rib for preventing optical and electrical interference between horizontally adjacent cells. On the lower substrate and the surface of the barrier rib is provided a phosphorus material excited by a vacuum ultraviolet ray UV to emit a visible light. An inactive mixture gas such as He+Xe, Ne+Xe or He+Ne+Xe is injected into a discharge space between the upper substrate and the lower substrate.

Such a three-electrode, AC surface discharge PDP is divided into a plurality of sub-fields for it's driving. In each sub-field period, an emission having a frequency proportional to a weighting value of a video data is conducted to provide a gray scale display.

FIG. 2 depicts a sub-field configuration according to a conventional PDP driving method carrying out a selective writing and a selective erasing at the same time.

Referring to FIG. 2, in a method of driving the three-electrode, AC surface-discharge PDP, one frame includes sub-fields SF1 to SF6 employing a selective writing system and sub-fields SF7 and SF12 employing a selective erasing system. The first sub-field SF1 is divided into a reset period for turning off a full field, a selective writing address period for turning on the selected discharge cells, a sustain period for making a sustain discharge of the discharge cells selected by the address discharge, and an erase period for erasing the sustain discharge. Each of the second to fifth sub-fields SF2 and SF5 is divided into a selective writing address period, a sustain period and an erase period. Further, the sixth sub-field SF6 is divided into a selective writing address period and a sustain period. In the first to sixth sub-fields SF1 to SF6, the selective writing address period and the erase period are same for each sub-field, whereas the sustain period is increased at a ration of 2ⁿ (wherein n=0, 1, 2, 3, 4, 5, 6 and 7) at each sub-field. Each of the seventh to twelfth sub-fields SF7 to SF12 is divided into a selective erasing address period for turning off the selected discharge cells without an entire writing period at which the full field is written, and a sustain period for making a sustain discharge of the discharge cells other than the discharge cells selected by the address discharge. In the seventh to twelfth sub-fields SF7 to SF12, the selective erasing address period as well as the sustain period is set to the same value. The sustain period of each of the seventh to twelfth sub-fields SF7 to SF12 is set to a brightness relative ratio of 25 to have has the same brightness relative ratio as the sixth sub-field SF6.

Each of the seventh to twelfth sub-fields SF7 to SF12 driven by the selective erasing system should have the previous sub-field turned on necessarily in order to turn off unessential discharge cells whenever the sub-fields are succeeded. For instance, if it is intended to have the seventh sub-field SF7, it is necessary to have the sixth sub-field SF6, which is the previous sub-field, driven by the selective writing system. After the sixth sub-field SF6 was turned on in this manner, the unessential discharge cells from the seventh to twelfth sub-fields SF7 to SF12 are going to be turned off. To this end, if it is intended to use the selective erasing sub-field ESF, the cells turned on at the sixth sub-field SF6, which is the last selective writing sub-field WSF, should be sustained in a state turned on by the sustain discharge. Accordingly, the seventh sub-field sf7 dose not need an additional writing discharge for providing a selective erasing address. Further, the eighth to twelfth sub-fields SF8 to SF12 also selectively turn off the cells turned on at the previous sub-field without an entire writing.

FIG. 3 depicts a driving waveform according to the PDP driving method shown in FIG. 2.

Referring to FIG. 3, in the reset period or the set-up period of the first selective writing sub-field S1, a reset pulse −RP taking a ramp-down waveform, following a reset pulse RP taking a ramp-up waveform, is sequentially applied to the scan electrode lines Y. The ramp-down reset pulse −RP falls into a negative(−) scanning reference voltage V_{W}. Further, a positive(+) scanning direct current (DC) voltage DCSC is applied to the sustain electrode lines Z.

In the address period of the selective writing sub-field SWI, a negative(−) selective writing scan pulse −SWSP and a positive(+) selective writing data pulse SWDP are applied to the scan electrode lines Y and the address electrode lines X, respectively, such that they are synchronized with each other, when the positive(+) scan DC voltage DCSC is being applied to the sustain electrode lines Z. Sustain pulses SUSPy and SUSPZ are alternately applied to the scan electrode lines Y and the sustain electrode lines Z such that the cells turned on by the address discharge of the selective writing sub-field SW causes a sustain discharge. Further, an erasing pulse EP causing an erasure of the sustain discharge is applied to the scan electrode lines Y at an end time of the second selective writing sub-field SW2.

The reset period of the selective erasing sub-field SE is omitted. In the address period of the selective erasing sub-field SE, a negative(−) selective erasing scan pulse SESP and a positive(+) selective erasing data pulse SEDP for turning off the cell are applied to the scan electrode lines Y and the address electrode lines X, respectively, such that they are synchronized with each other. The selective erasing scan pulse −SESP falls into a selective erasing scan voltage −Ve higher than the scanning reference voltage −V_{W}. The sustain pulses SUSPy and SUSPZ are alternately applied to the scan electrode lines Y and the sustain electrode lines Z such that the cells being not turned off by the address discharge of the selective erasing sub-field SE cause a sustain discharge. If the following next sub-field is the selective erasing field SE, then the sustain pulse SUSPy having a relatively large pulse width is applied to the scan electrode lines Y at an end time of the current selective erasing sub-field SE. Further, at the last selective erasing sub-field in which the next sub-field is the selective writing sub-field SW, an erasing pulse EP and a ramp signal RAMP are applied to the scan electrode lines Y and the sustain electrode lines Z are applied to erase a sustain discharge of the turned-on cells.

FIG. 4 illustrates a sub-field arrangement for displaying 256 gray levels in a sub-field arrangement according to the PDP driving method shown in FIG. 2.

Referring to FIG. 4, in the conventional sub-field arrangement for displaying 256 gray levels, sub-fields extending from the low gray level until the first 32 gray levels, that is, the first to sixth sub-fields SF1 to SF6 display the corresponding gray levels by the sustain discharge using the selective writing address discharge; and the remaining sub-fields being comprised of 32 gray levels, that is, the seventh to twelfth sub-fields SF7 and SF12 display the corresponding gray levels by the sustain discharge using the selective erasing address discharge. Such a PDP driving method carrying out the selective writing and the selective erasing at the same time fails to have a free sub-field arrangement because the sub-fields SF7 to SF12 employing the selective erasing system are driven dependently of a wall charge state of the previous sub-field as described in FIG. 2. Particularly, a PDP driven by carrying out the selective writing and the selective erasing at the same time at the 50 Hz video standard as shown in FIG. 4B causes a phenomenon in which a vertical frame blank (VFB) is relatively increased in comparison to a PDP driven at the 60 Hz video standard as shown in FIG. 4A (i.e., VFB1<VFB2). For this reason, a conventional PDP driven at the 50 Hz video standard has a drawback in that it causes a generation of wide-band flicker and a deterioration of picture quality.

Moreover, in the conventional PDP, a duty circle of light emission for the middle gray level expression, that is, for the middle gray scale is less than 50% as seen from FIG. 5. Such a phenomenon reduces a frequency component magnitude of 50 Hz from its spectrum as well as reducing wide-band flicker defects. However, the reduced wide-band flicker brings about a picture quality obstacle because of a large dimension of the PDP having a large viewing angle.

### SUMMARY OF THE INVENTION

Accordingly, it is an object of the present invention to provide a method of driving a plasma display panel wherein a vertical frame blank can be reduced to eliminate a wide-band flicker, thereby improving a picture quality.

In order to achieve these and other objects of the invention, a method of driving a plasma display panel according to an embodiment of the present invention that has first and second sustain electrodes and an address electrode and includes at least one selective writing sub-fields for expressing a low gray level by turning on selected discharge cells and sustaining a discharge of the turned-on cells, and at least one selective erasing sub-fields for expressing a high gray level by sequentially turning off the cells turned on at the last selective writing sub-field of said selective writing sub-fields, wherein any one of said selective erasing sub-fields is divided into at least two sub-fields in such a manner to be arranged into low gray level sub-fields.

In the method, said plasma display panel including the selective writing sub-fields and the selective erasing sub-fields is driven with a 50 Hz video standard.

Any one of said sub-fields is any one of said selective erasing sub-fields other than the first selective erasing sub-field and the last two selective erasing sub-fields.

A gray level sum of said sub-fields arranged into said at least two low gray level sub-fields is 32.

Otherwise, a gray level sum of said sub-fields arranged into said at least two low gray level sub-fields is less than 32 which is obtained by eliminating a portion of the low gray level sub-fields.

Said selected and divided low gray level sub-fields are comprised of sub-fields employing a selective writing scheme.

Said sub-field using the selective erasing scheme, being positioned in succession of any one sub-field of said selective erasing sub-fields divided into said low gray level sub-fields, is converted into a sub-field using a selective writing scheme.

Said at least two low gray level sub-fields have gray level arrangement shapes such as (1,2,4,8,16), (2,2,4,8,16), (4,4,8,16) and (8,8,16).

Herein, said at least two low gray level sub-fields have gray level arrangement shapes such as (2,4,8,16) and (4,8,16).

The method includes the steps of allowing one frame including sub-fields in which any one of said selective erasing sub-fields are divided into at least two sub-fields to turn on discharge cells selected by the selective writing sub-fields and sustain a discharge of said turned-on cells; turning off discharge cells unessential for cells in which the last selective writing sub-field of said selective writing sub-fields has been turned on, using the selective erasing sub-fields preceding the divided selective erasing sub-field; converting said divided selective sub-fields and one selective erasing sub-field following the divided sub-fields into selective writing sub-fields; turning on the selected discharge cells using the said converted selective writing sub-fields and sustaining a discharge of the turned-on cells; and turning off discharge cells unessential for the cells turned on at the last selective writing sub-field of said converted selective writing sub-fields, using the remaining selective erasing sub-fields.

A method of driving a plasma display panel according to another embodiment of the present invention, having first and second sustain electrodes and an address electrode and including at least one selective writing sub-fields for expressing a low gray level by turning on selected discharge cells and sustaining a discharge of the turned-on cells, and at least one selective erasing sub-fields for expressing a high gray level by sequentially turning off the cells turned on at the last selective writing sub-field of said selective writing sub-fields, includes the steps of dividing any one of said selective erasing sub-fields into at least two sub-fields to arrange low gray level sub-fields; converting said divided low gray level sub-fields into sub-fields employing a selective writing scheme; and arranging each sub-field displaying the same gray level from said selective writing sub-fields and said converted sub-fields employing the selective writing scheme at the same gap of emission center.

In the method, said plasma display panel including the selective writing sub-fields and the selective erasing sub-fields is driven with a 50 Hz video standard.

Said same gap of emission center is approximately 10 ms.

Any one of said sub-fields is any one of said selective erasing sub-fields other than the first selective erasing sub-field and the last two selective erasing sub-fields.

A gray level sum of said sub-fields arranged into said at least two low gray level sub-fields is 32.

A gray level sum of said sub-fields arranged into said at least two low gray level sub-fields is less than 32 which is obtained by eliminating a portion of the low gray level sub-fields.

Said selected and divided low gray level sub-fields are comprised of sub-fields employing a selective writing scheme.

Said sub-field using the selective erasing scheme, being positioned in succession of any one sub-field of said selective erasing sub-fields divided into said low gray level sub-fields, is converted into a sub-field using a selective writing scheme.

Said at least two low gray level sub-fields have gray level arrangement shapes such as (1,2,4,8,16), (2,2,4,8,16), (4,4,8,16) and (8,8,16).

Said at least two low gray level sub-fields have gray level arrangement shapes such as (2,4,8,16) and (4,8,16).

### BRIEF DESCRIPTION OF THE DRAWINGS

These and other objects of the invention will be apparent from the following detailed description of the embodiments of the present invention with reference to the accompanying drawings, in which:

FIG. 1 illustrates an electrode arrangement of a conventional three-electrode, AC surface-discharge plasma display panel;

FIG. 2 depicts a sub-field configuration according to a conventional plasma display panel driving method carrying out a selective writing and a selective erasing at the same time;

FIG. 3 depicts a driving waveform according to the plasma display panel driving method shown in FIG. 2;

FIG. 4 illustrates a sub-field arrangement for displaying 256 gray levels in the sub-field arrangement according to the plasma display panel driving method shown in FIG. 2;

FIG. 5 illustrates a duty circle of light emission for a middle gray level expression in the conventional plasma display panel driving method;

FIG. 6 depicts a plasma display panel driving method carrying out a selective writing and a selective erasing according to a first embodiment of the present invention at the same time;

FIG. 7 depicts a plasma display panel driving method carrying out a selective writing and a selective erasing according to a second embodiment of the present invention at the same time; and

FIG. 8 depicts a plasma display panel driving method carrying out a selective writing and a selective erasing according to a third embodiment of the present invention at the same time.

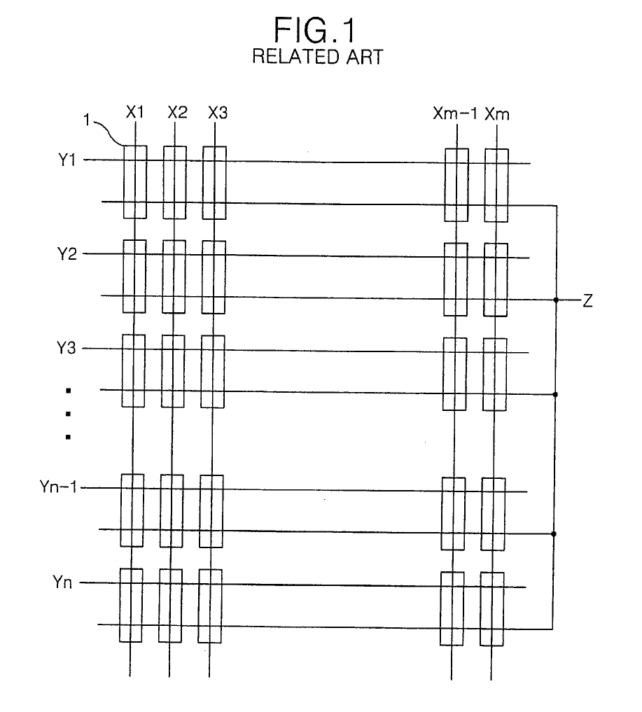

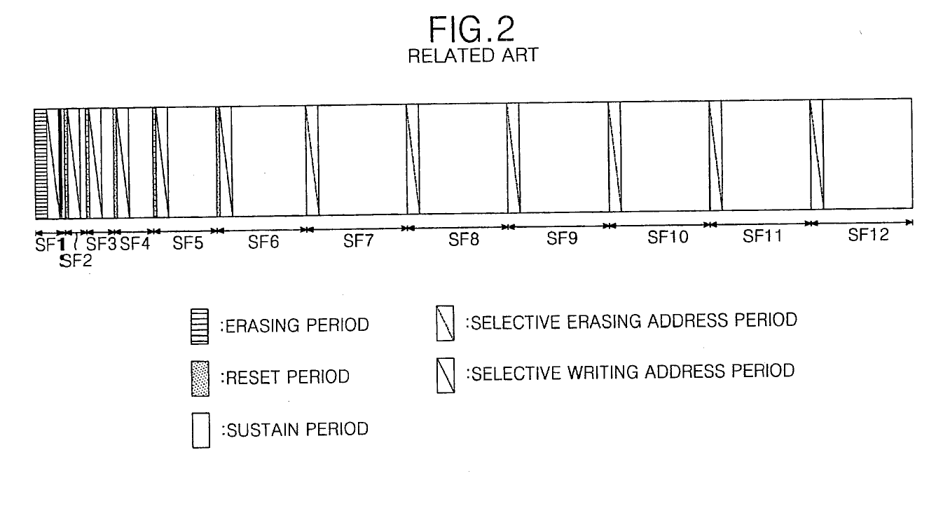

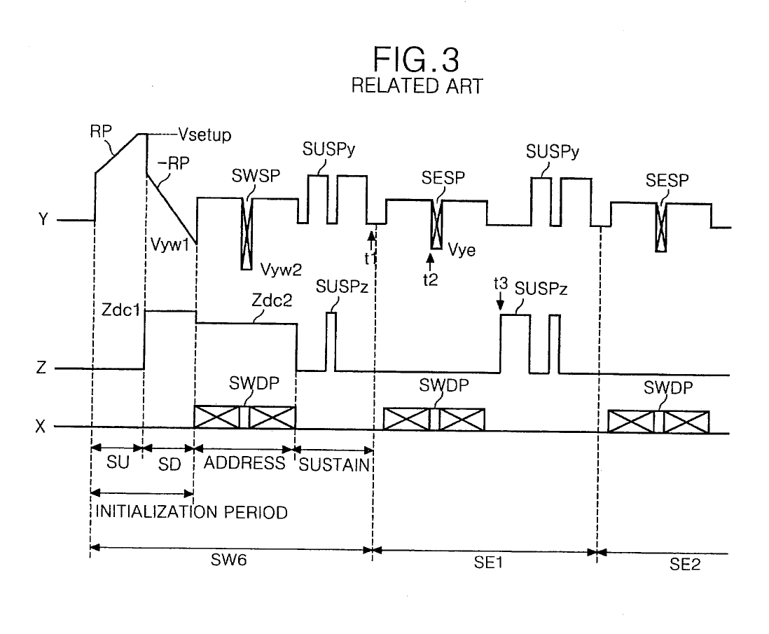

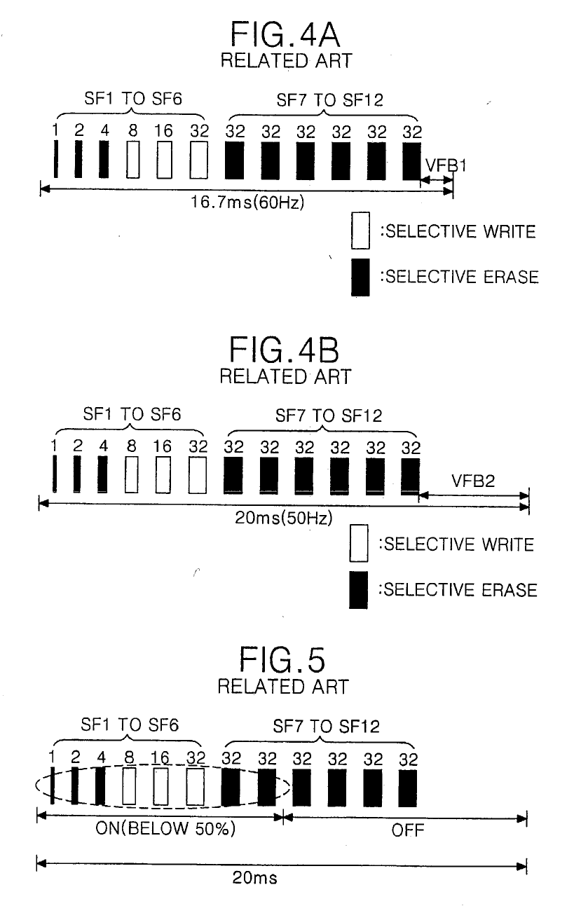

### DETAILED DESCRIPTION OF THE PREFERRED EMBODIMENT

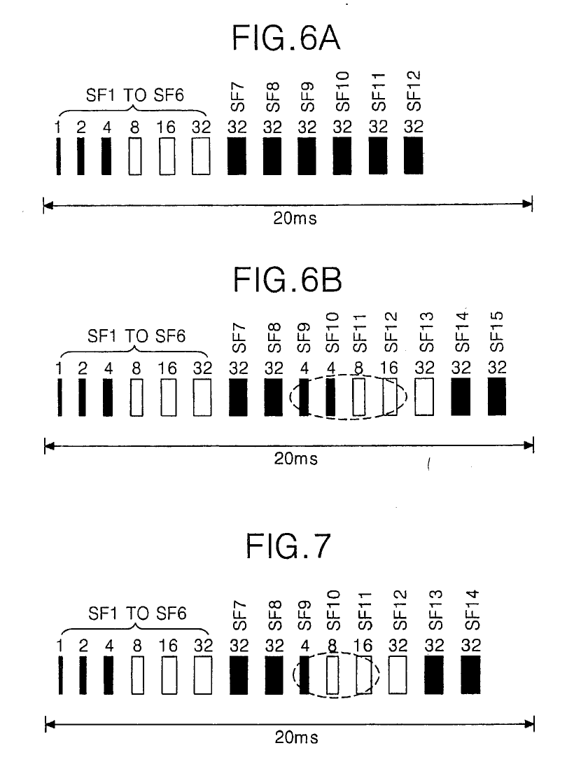

FIG. 6 depicts a plasma display panel (PDP) driving method carrying out a selective writing and a selective erasing according to a first embodiment of the present invention at the same time. Particularly, FIG. 6 shows a comparison of a sub-field configuration within one frame for implementing 256 gray levels upon 50 Hz video standard driving.

Herein, FIG. 6A shows a sub-field configuration in the PDP driving method carrying out a selective writing and a selective erasing according to the prior art, whereas FIG. 6B shows a sub-field configuration in the PDP driving method carrying out a selective writing and a selective erasing according to a first embodiment of the present invention.

Referring to FIG. 6, in the PDP driving method according to the first embodiment of the present invention, one frame is comprised of sub-fields SF1 to SF6 employing a selective writing scheme and sub-fields SF7 to SF12 employing a selective erasing scheme. Herein, in the sub-fields SF8 to SF10 excluding the seventh, eleventh and twelfth sub-fields SF7, SF11 and SF12 from the sub-fields SF7 to SF12 employing the selective erasing scheme, one sub-field is arranged such that it is divided into at least two sub-fields. Any one of the sub-fields SF8 to SF10 divided into at least two sub-fields is combined with at least two sub-fields consisting of 2ⁿ (wherein n=0, 1, 2, 3, 4) gray levels to satisfy 32 gray levels. Herein, the sub-fields for displaying 32 gray levels take various gray level arrangement shapes such as (1,2,4,8,16), (2,2,4,8,16), (4,4,8,16) or (8,8,16), etc.

Such divided selective erasing sub-fields is converted into the selective writing sub-fields. Furthermore, the selective erasing sub-field following any one divided sub-field of the selective erasing sub-fields SF8 to SF10 also is converted into the selective writing sub-field. This aims at increasing a freedom of sub-field mapping so as to provide a 256 gray level expression.

For instance, FIG. 6B shows a case where the ninth sub-field SF9 in FIG. 6A is divided into four sub-fields. The ninth sub-field SF9 having 32 gray levels in FIG. 6A is converted into the ninth, tenth, eleventh and twelfth sub-fields SF9, SF10, SF11 and SF12 having 4, 4, 8, 16 gray levels, respectively. In this case, the ninth sub-field SF9 in FIG. 6A is comprised of an address period and a sustain period depending upon a sub-field configuration taking the selective erasing scheme, whereas the ninth to twelfth sub-fields SF9 to SF12 in FIG. 6B is converted into a sub-field configuration taking the selective writing scheme to include an address period, a sustain period and an erasing period. Further, the tenth sub-field SF10 in FIG. 6A becomes the thirteenth sub-field SF13 in FIG. 6B due to the divided sub-fields as mentioned above, and the thirteenth sub-field SF13 in FIG. 6B follows the previously divided sub-fields to have a sub-field configuration taking the selective writing scheme. In this case, the thirteenth sub-field SF13 in FIG. 6B also has a configuration including an address period, a sustain period and an erase period. The sub-fields after the thirteenth sub-field SF13 again has a sub-field configuration taking the selective erasing scheme, and they are driven only when the thirteenth sub-field SF13 is enlarged. After the thirteenth sub-field SF13 was turned on in this manner, the discharge cells unessential to the sub-fields after the thirteenth sub-field SF13, that is, the fourteenth and fifteenth sub-fields SF14 and SF15 is going to be turned off. To this end, if it is intended that the fourteenth and fifteenth sub-fields SF14 and SF15 are used as the selective erasing sub-field, then the cells turned on at the thirteenth sub-field SF13, which is the last selective writing sub-field, should be sustained in a state turned on by the sustain discharge.

In the PDP driving method having the configuration as mentioned above, one frame is comprised of at least 13 sub-fields to reduce a vertical frame blank (VFB) and increases the number of sub-fields taking the selective writing scheme to raise a freedom of sub-field mapping, thereby extending a duty circle of light emission for a middle gray level expression into more than 50%. As a result, the PDP driving method having the sub-field arrangement according to the first embodiment of the present invention can reduce or substantially eliminate a wide-band flicker against the 50 Hz video standard, thereby improving a picture quality.

FIG. 7 depicts a plasma display panel (PDP) driving method carrying out a selective writing and a selective erasing according to a second embodiment of the present invention at the same time. Particularly, FIG. 7 shows a comparison of a sub-field configuration within one frame for implementing 256 gray levels upon 50 Hz video standard driving.

Herein, FIG. 7 shows an elimination of a portion of sub-fields having a low gray level of the divided sub-fields in comparison with a sub-field configuration according to the first embodiment in FIG. 6B.

Referring to FIG. 7, the PDP driving method according to the second embodiment of the present invention has the same configuration and operation as that having been described with reference to FIG. 6.

For instance, in FIG. 6B, one sub-field having 32 gray levels has been divided to have 4, 4, 8 and 16 gray levels, thereby being comprised of the ninth, tenth, eleventh and twelfth sub-fields SF9, SF10, SF11 and SF12. However, the sub-field of low gray level generally does not induce a 50 Hz wide-band flicker because it has a small emission weighting value. This results in eliminating a portion of the sub-field having a low gray level of the divided sub-fields. Accordingly, in the PDP driving method according to the second embodiment of the present invention, one frame is comprised of sub-fields having a smaller number than the first embodiment. For example, the sub-fields in which a portion of the low gray level sub-field is eliminated to display gray levels less than 32 take various gray level arrangement shapes such as (2,4,8,16) or (4,8,16), etc.

Accordingly, in the PDP driving method shown in FIG. 7, one frame is comprised of 14 sub-fields. The first to sixth sub-fields SF1 to SF6 is configured by a sub-field employing the selective writing scheme to conduct a light emission having a frequency sequentially proportional to a weighting value of 2ⁿ (wherein n=0, 1, 2, 3, 4, 5), thereby providing a gray level expression. Next, the seventh and eighth sub-fields SF7 and SF8 consist of a sub-field employing the selective erasing scheme, and they are driven only when the sixth sub-field SF6, which is the last sub-field, is turned on. After the sixth sub-field SF6 was turned on in this manner, the seventh and eighth sub-fields SF7 and SF8 are going to turn off unessential discharge cells.

Subsequently, the ninth to twelfth sub-fields SF9 to SF12 configured by dividing the ninth sub-field SF9 in FIG. 6A consist of a sub-field employing the selective writing scheme. In this case, the ninth to eleventh sub-fields SF9 to SF11 are combined from an elimination of a low gray level of sub-field having a small emission weighting value, thereby preventing a display of 32 gray levels. Further, the twelfth sub-field SF12 following these sub-fields also is configured by the selective writing scheme in succession of the ninth to eleventh sub-fields SF9 to SF11 to display 32 gray levels using a weighting value of ₂5.

The thirteenth and fourteenth sub-fields SF13 and SF14 following the ninth to twelfth sub-fields SF9 and SF12 are converted into sub-fields employing the selective writing scheme and are comprised of sub-fields employing the selective erasing scheme in order to turn off the unessential discharge cells of the driven discharge cells. In this case, the thirteenth to fourteenth sub-fields SF13 and SF14 are driven only when the twelfth sub-field SF12, which is the last sub-field of the sub-fields converted into the sub-fields employing the selective writing scheme, should be turned on. After the twelfth sub-field SF12 was turned on in this manner, the unessential discharge cells from the thirteenth and fourteenth sub-fields SF13 and SF14 is going to be turned on. In other words, if it is intended that the thirteenth and fourteenth sub-fields SF13 and SF14 are used as the selective erasing sub-field, then the cells turned on at the twelfth sub-field SF12, which is the last selective writing sub-field, should be sustained in a state turned on by the sustain discharge.

Likewise, in the PDP driving method having the configuration as mentioned above, one frame is comprised of at least 13 sub-fields to reduce a vertical frame blank (VFB) and increases the number of sub-fields taking the selective writing scheme to raise a freedom of sub-field mapping, thereby extending a duty circle of light emission for a middle gray level expression into more than 50%. As a result, the PDP driving method having the sub-field arrangement according to the second embodiment of the present invention also can reduce or substantially eliminate a wide-band flicker against the 50 Hz video standard, thereby improving a picture quality.

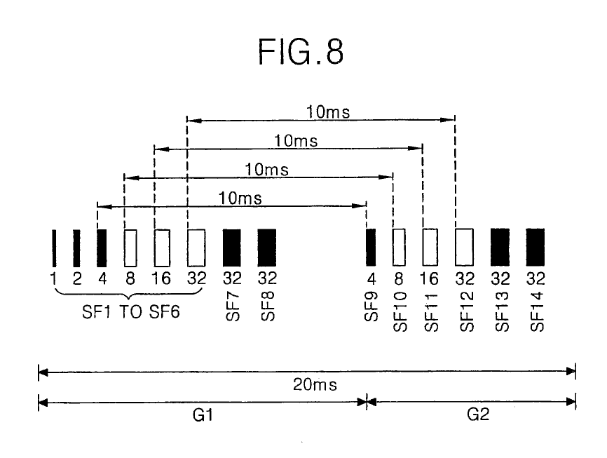

FIG. 8 depicts a plasma display panel (PDP) driving method carrying out a selective writing and a selective erasing according to a third embodiment of the present invention at the same time.

Referring to FIG. 8, in the PDP driving method according to the third embodiment of the present invention, one frame is comprised of two individual first and second sub-field groups G1 and G2. Each of the first and second sub-field groups includes sub-fields employing the selective writing scheme and sub-fields employing the selective erasing scheme. Further, a gap of an emission center for the first sub-fields having the same gray level provided at the first and second sub-field groups G1 and G2 is arranged at a difference of 10 ms.

The number of sub-fields belonging to the first and second sub-fields G1 and G2 is defined by arranging any one sub-field of the remaining sub-fields SF8 to SF10 excluding the seventh, eleventh and twelfth sub-fields SF7, SF11 and SF12 from the sub-fields employing the selective erasing scheme such that it is divided into at least two sub-fields and by converting the selective erasing sub-field following the divided sub-fields into the sub-fields employing the selective writing scheme.

In the divided sub-fields, 1, 2, 4, 8 and 16 gray levels are combined by a weighting value of 2ⁿ (wherein n=0, 1, 2, 3, 4, 5) to display 32 gray levels or gray levels less than 32. For instance, the sub-fields displaying 32 gray levels take various gray level arrangement shapes, whereas the sub-fields displaying gray levels less than 32 takes various gray level arrangement shapes such as (2,4,8,16) or (4,8,16), etc. in which a portion of the low gray level sub-field is eliminated from the sub-fields displaying 32 gray levels.

This will be described by comparing the embodiment shown in FIG. 8 with that shown in FIG. 7.

First, FIG. 8 has a sub-field arrangement eliminating a portion of the low gray level as shown in FIG. 7 to express gray levels equal to or less than 256 within one frame.

In the PDP driving method shown in FIG. 8, one frame is comprised of 14 sub-fields. The first to sixth sub-fields SF1 to SF6 is configured by a sub-field employing the selective writing scheme to conduct a light emission having a frequency sequentially proportional to a weighting value of 2ⁿ (wherein n=0, 1, 2, 3, 4, 5), thereby providing a gray level expression. Next, the seventh and eighth sub-fields SF7 and SF8 consist of a sub-field employing the selective erasing scheme, and they are driven only when the sixth sub-field SF6, which is the last sub-field, is turned on. After the sixth sub-field SF6 was turned on in this manner, the seventh and eighth sub-fields SF7 and SF8 are going to turn off unessential discharge cells.

Subsequently, the ninth to twelfth sub-fields SF9 to SF12 configured by dividing the ninth sub-field SF9 in FIG. 6A consist of a sub-field employing the selective writing scheme. In this case, the ninth to eleventh sub-fields SF9 to SF11 are combined by an elimination of a low gray level of sub-field having a small emission weighting value, thereby displaying 28 gray levels which are smaller than 28 gray levels. Further, the twelfth sub-field SF12 following these sub-fields also is configured by the selective writing scheme in succession of the ninth to eleventh sub-fields SF9 to SF11 to display 32 gray levels using a weighting value of 2⁵. In this case, the second sub-field group begins with the ninth sub-field SF9 at which the selective writing sub-field begins, and the first to eighth sub-fields SF1 to SF8 becomes the first sub-field group.

The thirteenth and fourteenth sub-fields SF13 and SF14 following the ninth to twelfth sub-fields SF9 and SF12 are converted into sub-fields employing the selective writing scheme and are comprised of sub-fields employing the selective erasing scheme in order to turn off the unessential discharge cells of the driven discharge cells. In this case, the thirteenth to fourteenth sub-fields SF13 and SF14 are driven only when the twelfth sub-field SF12, which is the last sub-field of the sub-fields converted into the sub-fields employing the selective writing scheme, should be turned on. After the twelfth sub-field SF12 was turned on in this manner, the unessential discharge cells from the thirteenth and fourteenth sub-fields SF13 and SF14 is going to be turned on. In other words, if it is intended that the thirteenth and fourteenth sub-fields SF13 and SF14 are used as the selective erasing sub-field, then the cells turned on at the twelfth sub-field SF12, which is the last selective writing sub-field, should be sustained in a state turned on by the sustain discharge.

Herein, a gap of an emission center for the first sub-fields having the same gray level provided at the first and second sub-field groups G1 and G2 is arranged at a difference of 10 ms. More specifically, the ninth sub-field SF9 displaying four gray levels from the second sub-field group G2 is arranged such that a gap of emission center thereof makes a difference of 10 ms with respect to the third sub-field SF3 displaying four gray levels from the first sub-field group G1. Further, the tenth to twelfth sub-fields SF10 to SF12 displaying 8, 16 and 32 gray levels, respectively, from the second sub-field group G2 also are arranged such that a gap of emission center thereof makes a difference of 10 ms with respect to the fourth, fifth and sixth sub-fields SF4, SF5 and SF6, displaying 8, 16 and 32 gray levels, respectively.

In the PDP driving method having the configuration as mentioned above, the number of sub-fields in one frame is increased to reduce the vertical frame blank VFB and to enlarge a duty circle of light emission for the middle gray level expression, thereby eliminating a 50 Hz wide-band flicker.

As described above, in the plasma display panel driving method carrying out the selective writing and the selective erasing at the same time according to the present invention, any one of the sub-fields at the selective erasing sub-field range is divided into at least two sub-fields, and the divided sub-field and the sub-field following the divided sub-field is converted into the selective writing sub-fields. Accordingly, the number of sub-fields in one frame is increased to reduce the vertical frame blank VFB and to enlarge a duty circle of light emission for the middle gray level expression, thereby eliminating a 50 Hz wide-band flicker.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A method of driving a plasma display panel having first and second sustain electrodes and an address electrode and including at least one selective writing sub-fields for expressing a low gray level by turning on selected discharge cells and sustaining a discharge of the turned-on cells, and at least one selective erasing sub-fields for expressing a high gray level by sequentially turning off the cells turned on at the last selective writing sub-field of said selective writing sub-fields, wherein any one of said selective erasing sub-fields is divided into at least two sub-fields in such a manner to be arranged into low gray level sub-fields.

2. The method as claimed in claim 1, wherein said plasma display panel including the selective writing sub-fields and the selective erasing sub-fields is driven with a 50 Hz video standard.

3. The method as claimed in claim 2, wherein any one of said sub-fields is any one of said selective erasing sub-fields other than the first selective erasing sub-field and the last two selective erasing sub-fields.

4. The method as claimed in claim 2, wherein a gray level sum of said sub-fields arranged into said at least two low gray level sub-fields is 32.

5. The method as claimed in claim 2, wherein a gray level sum of said sub-fields arranged into said at least two low gray level sub-fields is less than 32 which is obtained by eliminating a portion of the low gray level sub-fields.

6. The method as claimed in claim 3, wherein said selected and divided low gray level sub-fields are comprised of sub-fields employing a selective writing scheme.

7. The method as claimed in claim 6, wherein said sub-field using the selective erasing scheme, being positioned in succession of any one sub-field of said selective erasing sub-fields divided into said low gray level sub-fields, is converted into a sub-field using a selective writing scheme.

8. The method as claimed in claim 4, wherein said at least two low gray level sub-fields have gray level arrangement shapes such as (1,2,4,8,16), (2,2,4,8,16), (4,4,8,16) and (8,8,16).

9. The method as claimed in claim 5, wherein said at least two low gray level sub-fields have gray level arrangement shapes such as (2,4,8,16) and (4,8,16).

10. The method as claimed in claim 5, comprising the steps of:
allowing one frame including sub-fields in which any one of said selective erasing sub-fields are divided into at least two sub-fields to turn on discharge cells selected by the selective writing sub-fields and sustain a discharge of said turned-on cells;
turning off discharge cells unessential for cells in which the last selective writing sub-field of said selective writing sub-fields has been turned on, using the selective erasing sub-fields preceding the divided selective erasing sub-field;
converting said divided selective sub-fields and one selective erasing sub-field following the divided sub-fields into selective writing sub-fields;
turning on the selected discharge cells using the said converted selective writing sub-fields and sustaining a discharge of the turned-on cells; and
turning off discharge cells unessential for the cells turned on at the last selective writing sub-field of said converted selective writing sub-fields, using the remaining selective erasing sub-fields.

11. A method of driving a plasma display panel having first and second sustain electrodes and an address electrode and including at least one selective writing sub-fields for expressing a low gray level by turning on selected discharge cells and sustaining a discharge of the turned-on cells, and at least one selective erasing sub-fields for expressing a high gray level by sequentially turning off the cells turned on at the last selective writing sub-field of said selective writing sub-fields, said method comprising the steps of:
dividing any one of said selective erasing sub-fields into at least two sub-fields to arrange low gray level sub-fields;
converting said divided low gray level sub-fields into sub-fields employing a selective writing scheme; and
arranging each sub-field displaying the same gray level from said selective writing sub-fields and said converted sub-fields employing the selective writing scheme at the same gap of emission center.

12. The method as claimed in claim 11, wherein said plasma display panel including the selective writing sub-fields and the selective erasing sub-fields is driven with a 50 Hz video standard.

13. The method as claimed in claim 12, wherein said same gap of emission center is approximately 10 ms.

14. The method as claimed in claim 13, wherein any one of said sub-fields is any one of said selective erasing sub-fields other than the first selective erasing sub-field and the last two selective erasing sub-fields.

15. The method as claimed in claim 13, wherein a gray level sum of said sub-fields arranged into said at least two low gray level sub-fields is 32.

16. The method as claimed in claim 13, wherein a gray level sum of said sub-fields arranged into said at least two low gray level sub-fields is less than 32 which is obtained by eliminating a portion of the low gray level sub-fields.

17. The method as claimed in claim 14, wherein said selected and divided low gray level sub-fields are comprised of sub-fields employing a selective writing scheme.

18. The method as claimed in claim 17, wherein said sub-field using the selective erasing scheme, being positioned in succession of any one sub-field of said selective erasing sub-fields divided into said low gray level sub-fields, is converted into a sub-field using a selective writing scheme.

19. The method as claimed in claim 15, wherein said at least two low gray level sub-fields have gray level arrangement shapes such as (1,2,4,8,16), (2,2,4,8,16), (4,4,8,16) and (8,8,16).

20. The method as claimed in claim 16, wherein said at least two low gray level sub-fields have gray level arrangement shapes such as (2,4,8,16) and (4,8,16).
